(19) United States
(12) Patent Application Publication
(10) Pub. No.: US 2021/0076240 A1
(43) Pub. Date: Mar. 11, 2021

(54) METHOD, APPARATUS AND COMPUTER PROGRAM FOR PERFORMING MEASUREMENTS IN NEW RADIO (NR)

(71) Applicant: NOKIA TECHNOLOGIES OY, Espoo (FI)

(72) Inventors: Dawid Koziol, Wroclaw (PL); Jarkko Tuomo Koskela, Oulu (FI)

(21) Appl. No.: 16/764,323

(22) PCT Filed: Nov. 16, 2017
(86) PCT No.: PCT/EP2017/079531

§ 371 Date: May 14, 2020

(51) Int. Cl. H04W 24/10; H04W 24/08

(52) U.S. Cl. CPC H04W 24/10; H04W 24/08

(57) ABSTRACT

A method comprising: receiving measurement configuration information, the measurement configuration information comprising: an indication of a plurality of frequencies at which measurements are to be performed; and a first parameter; performing, in dependence upon the first parameter, one of: if the first parameter has a first value, measurements at the indicated plurality of frequencies; and if the first parameter has a second value, measurements at only one or more of the plurality of frequencies which fall within one or more predefined frequency ranges.

### FIELD

The present application relates to a method, apparatus, system and computer program and in particular but not exclusively to radio resource management (RRM) and user equipment (UE) measurements in New Radio (NR).

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. Standardization of 5G or New Radio networks is currently under discussion. These communication systems are being standardized by the 3rd Generation Partnership Project (3GPP).

### SUMMARY

According to a first aspect, there is provided a method comprising: receiving measurement configuration information, the measurement configuration information comprising: an indication of a plurality of frequencies at which measurements are to be performed; and a first parameter; performing, in dependence upon the first parameter, one of: if the first parameter has a first value, measurements at the indicated plurality of frequencies; and if the first parameter has a second value, measurements at only one or more of the plurality of frequencies which fall within one or more predefined frequency ranges.

In one embodiment, the measurement configuration information comprises a second parameter, wherein if the second parameter has a third value, the one or more predefined frequency ranges comprise active frequency ranges only, and wherein if the second parameter has a fourth value, the one or more predefined frequency ranges comprise at least one frequency range associated with a non-active secondary cell.

In one embodiment, the first parameter and the second parameter are part of a combined parameter.

According to a second aspect, there is provided a method comprising: receiving measurement configuration information, the measurement configuration information comprising an indication of a plurality of frequencies at which measurements are to be performed; and performing the measurements only at one or more of the frequencies which fall within one or more predefined frequency ranges.

In one embodiment, the measurements comprise one or more of measurements of: the block error rate, transmit power, and other device-based parameters claimed reference signal received power (RSRP), reference signal received quality (RSRQ), signal to interference and noise ratio (SINR).

In one embodiment, each of the one or more predefined frequency ranges is an active frequency range.

In one embodiment, each of the one or more predefined frequency ranges is an active bandwidth part.

In one embodiment, the measurement configuration information comprises a measurement object providing the indication of a plurality of frequencies at which measurements are to be performed.

In one embodiment, the method comprises receiving Radio Resource Control layer signalling comprising the measurement configuration information.

In one embodiment, the method comprises: performing filtering of measurement results made within an active frequency range using a filter; and in response to a change in the active frequency range to a new frequency range, performing at least one of: resetting the filter; and filtering new measurement results made within the new frequency range using the filter.

In one embodiment, the method comprises: associating a filter with each of a plurality of frequency ranges for the filtering of measurement results made within the frequency ranges; in response to one of the plurality of frequency ranges becoming active, activating the filter associated with that frequency range; and in response to one of the plurality of frequency ranges becoming non-active, activating the filter associated with that frequency range.

According to a third aspect, there is provided a method comprising: transmitting measurement configuration information, the measurement configuration information comprising: an indication of a plurality of frequencies at which measurements are to be performed; and a first parameter; receiving, in dependence upon the first parameter, one of: if the first parameter has a first value, results of measurements made at the indicated plurality of frequencies; and if the first parameter has a second value, results of measurements made at only one or more of the plurality of frequencies which fall within one or more predefined frequency ranges.

According to a fourth aspect, there is provided a computer program product for a computer, comprising software code portions for performing the steps of any of the first to third aspects when said product is run on the computer.

According to a fifth aspect, there is provided a user device comprising: at least one processor and at least one memory including a computer program code, the at least one memory and the computer program code configured to, with the at least one processor, cause the apparatus at least to: receive measurement configuration information, the measurement configuration information comprising: an indication of a plurality of frequencies at which measurements are to be performed; and a first parameter; perform, in dependence upon the first parameter, one of: if the first parameter has a first value, measurements at the indicated plurality of frequencies; and if the first parameter has a second value, measurements at only one or more of the plurality of frequencies which fall within one or more predefined frequency ranges.

According to a sixth aspect, there is provided a user device comprising: at least one processor and at least one memory including a computer program code, the at least one memory and the computer program code configured to, with the at least one processor, cause the apparatus at least to: receive measurement configuration information, the measurement configuration information comprising an indication of a plurality of frequencies at which measurements are to be performed; and perform the measurements only at one or more of the frequencies which fall within one or more predefined frequency ranges.

According to a seventh aspect, there is provided an apparatus comprising: at least one processor and at least one memory including a computer program code, the at least one memory and the computer program code configured to, with the at least one processor, cause the apparatus at least to: transmitting measurement configuration information, the measurement configuration information comprising: an indication of a plurality of frequencies at which measurements are to be performed; and a first parameter; receiving, in dependence upon the first parameter, one of: if the first parameter has a first value, measurements at the indicated plurality of frequencies; and if the first parameter has a second value, measurements at only one or more of the plurality of frequencies which fall within one or more predefined frequency ranges.

According to an eighth aspect, there is provided an apparatus comprising: means for receiving measurement configuration information, the measurement configuration information comprising: an indication of a plurality of frequencies at which measurements are to be performed; and a first parameter; and means for performing, in dependence upon the first parameter, one of: if the first parameter has a first value, measurements at the indicated plurality of frequencies; and if the first parameter has a second value, measurements at only one or more of the plurality of frequencies which fall within one or more predefined frequency ranges.

According to a ninth aspect, there is provided an apparatus comprising: means for receiving measurement configuration information, the measurement configuration information comprising an indication of a plurality of frequencies at which measurements are to be performed; and means for performing the measurements only at one or more of the frequencies which fall within one or more predefined frequency ranges.

According to a tenth aspect, there is provided an apparatus comprising: means for transmitting measurement configuration information, the measurement configuration information comprising: an indication of a plurality of frequencies at which measurements are to be performed; and a first parameter; and means for receiving, in dependence upon the first parameter, one of: if the first parameter has a first value, results of measurements made at the indicated plurality of frequencies; and if the first parameter has a second value, results of measurements made at only one or more of the plurality of frequencies which fall within one or more predefined frequency ranges.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a diagram illustrating bandwidth parts in a carrier signal;

FIG. 4 illustrates a series of steps that may be carried between a UE and base station.

FIG. 5 illustrates a method according to examples of the application;

FIG. 6 shows a schematic diagram of a control apparatus; and

FIG. 7 shows an example of a non-transitory computer readable medium.

### DETAILED DESCRIPTION

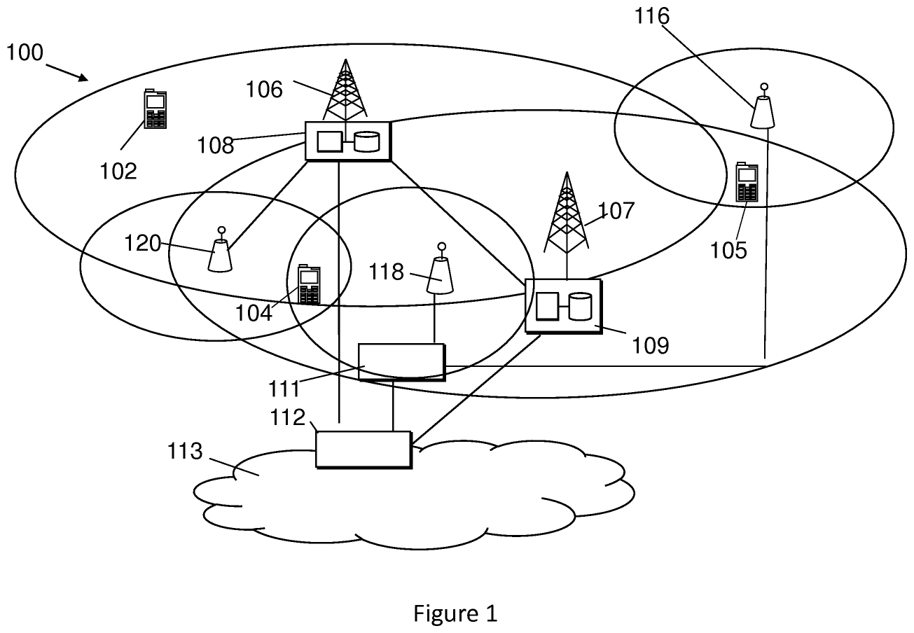

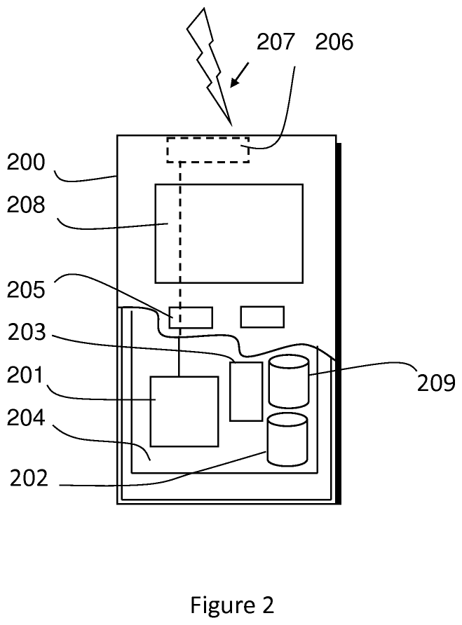

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be macro, pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

An example of wireless communication systems are architectures standardized by the 3rd Generation Partnership Project (3GPP). A 3GPP based development is often referred to as the long term evolution (LTE) of the Universal Mobile Telecommunications System (UMTS) radio-access technology. A latest 3GPP based development is often referred to as New Radio (NR). The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer Quality of Service (QoS) support, including some on-demand requirements for e.g. QoS levels to support Quality of Experience (QoE) of user point of view. Also network-aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV), which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

A device (such as device 200 shown in FIG. 2) may be configured to send data on the uplink to the base station, and receive data on the downlink from the base station. Certain parts of the frequency spectrum from be assigned for the uplink transmission, whilst other parts of the spectrum may be assigned for the downlink transmission.

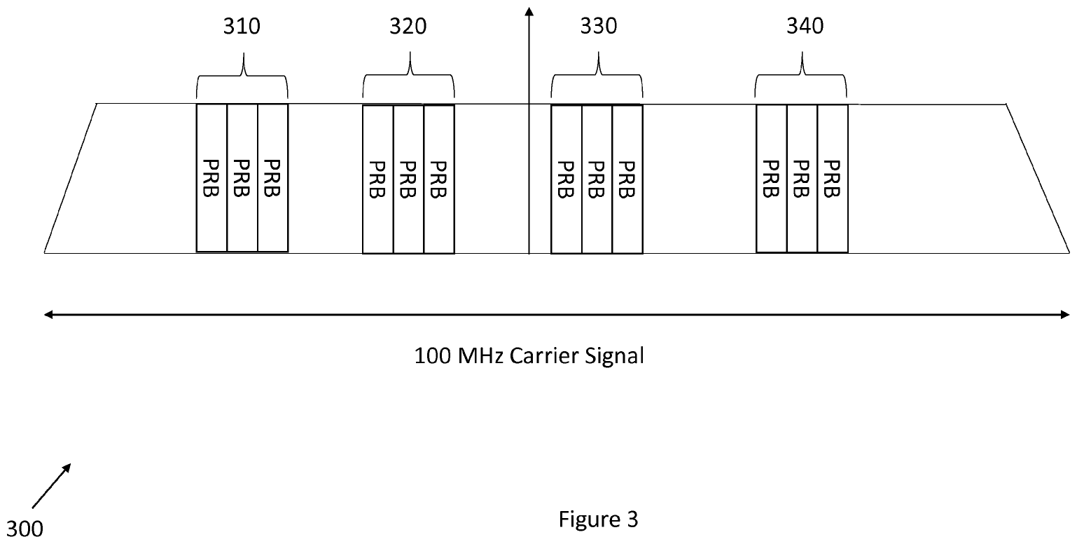

Reference is made to FIG. 3, which shows an example of a carrier signal 300 in which a device may be assigned portions of the carrier signal for reception and transmission. Each portion of the spectrum that is used in a cell may be referred to as a bandwidth part (BWP). The particular BWPs which are actively used for transmission and reception may be referred to as active BWPs. FIG. 3 shows how four different active BWPs may be located in a carrier signal of a cell. A device may be configured with one or more carrier bandwidth parts in the downlink with a subset of carrier bandwidth parts being active at a given time. A device may be configured to only receive PDSCH (Physical Downlink Shared Channel) or PDCCH (Physical Downlink Control Channel) inside an active bandwidth part. A device can be configured with one or more carrier bandwidth parts in the uplink with a subset of carrier bandwidth parts being active at a given time. The device may be configured to transmit PUSCH (Physical Uplink Shared Channel) or PUCCH (Physical Uplink Control Channel) only inside an active bandwidth part. A device does not expect to receive PDSCH or PDCCH outside an active bandwidth part and does not transmit PUSCH or PUCCH outside an active BWP.

Each bandwidth part may be a contiguous subset of the physical resource blocks. A physical resource block may be defined as a number of consecutive subcarriers in the frequency domain. In LTE, this number of consecutive subcarriers is twelve.

The carrier signal 300 is shown as being a 100 MHz carrier signal. However, other bandwidths are possible. The bandwidth may be 10 MHz or greater. The possible use of larger bandwidths makes embodiments of the application useful for future systems which are likely to use carrier signals having larger bandwidths. The carrier signal 300 may be a wideband carrier. A first active BWP 310 may be assigned for use by a first device for uplink transmission to the base station. A second active BWP 320 may be assigned for use by the first device for downlink reception from the base station. A third active BWP 330 of the carrier signal may be assigned for use by the second device for uplink transmission to the base station. A fourth active BWP 340 may be assigned for use by the second device for downlink reception from the base station. In some examples, there may be at most one DL active BWP and at most one active UL BWP at any given time for a given serving cell for a device. The active/non-active BWPs are assigned specifically to particular devices. Each device is configured with a set of BWPs and at a specific point in time, some of them will be active and some will not be active. Although not shown in the Figure, in some cases, the resources belonging to one BWP assigned to a first device may overlap with the resources belonging to another BWP assigned to a second device.

In 3GPP systems, the allocation of the bandwidth is cell-specific. In other cases, such as in NR, the BWPs can be configured specifically for particular devices (i.e. the allocation of bandwidth may be user-specific and/or device-specific). The base station may configure the bandwidth parts for the devices using dedicated signalling sent to the devices. The base station may determine a particular configuration for a device, dependent on the device's capabilities. For example, a device configured for operation in particular BWPs of a serving cell, may be configured by higher layer signalling for the serving cell a set (DL BWP set) of BWPs for receiving communication at the device from the base station of the serving cell. Similarly, such a device may be configured by higher signalling for serving cell a set (UL BWP set) of BWPs for transmissions by the device. The higher layer signalling may, for example, be Radio Resource Control (RRC) signalling.

According to current development of NR system and current agreements in 3GPP, BWP may operate with or without a synchronisation signal (SS) block, which is used to carry the NR-SS (Synchronization Signal) as well as the MIB (Master Information Block) and physical cell identity (PCI). One of the main drivers for introducing BWPs was to be able to support UEs with limited capabilities (in terms of Tx/Rx bandwidth) even on a wideband carrier deployed from system perspective. Another reason was to optimize UE's power consumption in periods of limited or no data transmission or reception activity, e.g. in such periods, UE may be switched (autonomously or by network command) to narrower BWP, so that number of resources it has to monitor is smaller.

In order to change which of a set of a BWPs are active for a particular device within a serving cell, the base station is configured to use layer 1 (i.e. physical layer) signalling, such as a scheduling DCI (Downlink Control Indicator). For example, in NR a signal scheduling DCI can switch a device's active BWP from one to another (of the same link direction) within a given serving cell.

A device may communicate with a plurality of cells, referred to as serving cells. The set of servicing cells comprises a primary cell (PCell), which is the cell operating on the primary frequency, in which the UE either performs the initial connection establishment procedure or initiates the connection re-establishment procedure, or the cell indicated as the primary cell in the handover procedure. The set of serving cells also comprises one or more secondary cells (SCell). A secondary cell is a cell operating on a secondary frequency, and which may be used to provide additional radio resources. In this case that a device is in communication with a plurality of serving cells, the higher layer (e.g. RRC) signalling may be used to configure 1 or more BWPs for the primary serving cell. Similarly, the higher layer signalling may be used to configure 0, 1 or more BWPs for a serving SCell.

For a device, the PCell, PSCell and each SCell may have a single associated synchronisation signal (SS) in frequency (RAN1 terminology is the ‘cell defining synchronisation signal’).

Cell defining SS block can be changed by synchronous reconfiguration or PCell/PSCell and SCell release/add for the cell.

Each SS block frequency which needs to be measured by the UE may be configured as an individual measurement object (i.e. one measurement object corresponds to a single SS block frequency).

The cell defining SS block may be considered as the time reference of the serving cell, and for Radio Resource Management serving cell measurements based on Single-Sideband (irrespective of which BWP is activated).

Upon instruction from a base station, the device may be configured to conduct requested measurements of the surrounding cells. The instructions may include a measurement object (described further below). The measurements can include measurements of the block error rate, transmit power, and other device-based parameters. The measurement may also include one or more of: reference signal received power (RSRP), reference signal received quality (RSRQ), signal to interference and noise ratio (SINR). These may be measured and reported on a cell level and/or beam level. The beam may be identified by a channel state information reference signal (CSI-RS) resource identifier or via SS block timing index. In multi-beam cell deployments, cell quality is derived based on averaging of a network configurable number of beams meeting a network configurable quality threshold. The device is configured to construct a measurement report including the measurements, which may be sent to the base station to inform the network of whatever results have been requested.

The device is configured to receive measurement configuration information from the base station and to determine the measurements that are to be performed. The measurement configuration information includes an indication of a frequency at which measurements are to be performed. This may be part of a measurement object (MO), which is included in the measurement configuration information. The measurement objects included in the configuration information define the objects on which the UE shall perform the measurements; i.e. frequencies and cells. Intra-frequency and inter-frequency measurement objects can specify individual cells to measure, and individual cells to exclude from measurements. Individual cells may be referenced in the measurement object by their Physical layer Cell Identities (PCI).

An MO may be provided to the device for all carriers on which measurements are to be performed. The information provided in measurement configuration information is used to derive serving cell measurements. The device determines what to measure for serving cells using the reference signal type(s) as identified in the configuration information. The device may perform serving cell measurements, even if a serving frequency MO is not linked to any reportConfig/measID. The device performs serving cell measurements for all serving frequencies for all measurement quantities (Reference Signal Receive Power and Reference Signal Receive Quality). If a measurement report is triggered, associated to any measurement ID, the device may include all available measurement results for PCell and configured SCells.

The measurement configuration principles in NR take the framework known from LTE as a baseline. However, as mentioned above, in NR some specificities need to be taken into account. These include BWPs and beam level measurements (i.e. SS blocks and/or CSI-RS resources), which are then used to derive cell level quality of the serving cell and its neighbouring cells.

As mentioned above, a device's active BWPs may be switched using physical layering signalling. This signalling is transparent to the higher layer (e.g. Radio Resource Control (RRC) layer) protocol responsible for measurement configuration. Therefore, the higher layer is not aware of which BWPs are active for a device. The RRC layer is responsible for the configuration of the BWPs and hence is at least aware of which BWP can be active at a given time (i.e. it knows this is at least one of the configured ones, but does not know which one exactly at a certain point in time). At the same time, measurements made by the UE on either SS blocks or CSI-RS resources located outside UE's active BWP, are inter-frequency measurements and require measurement gaps to be configured for the UE.

A measurement may be defined as a SSB (SS block) based intra-frequency measurement provided the center frequency of the SSB of the serving cell indicated for measurement and the center frequency of the SSB of the neighbour cell are substantially the same, and the subcarrier spacing of the two SSBs are also the same. A measurement may be defined as a SSB based inter-frequency measurement provided the center frequency of the SSB of the serving cell indicated for measurement and the center frequency of the SSB of the neighbour cell are different, or the subcarrier spacing of the two SSBs are different. A measurement may be defined as a CSI-RS based intra-frequency measurement provided the bandwidth of the CSI-RS resource on the neighbour cell configured for measurement is within the bandwidth of the CSI-RS resource on the serving cell configured for measurement, and the subcarrier spacing of the two CSI-RS resources are the same. A measurement may be defined as a CSI-RS based inter-frequency measurement provided the bandwidth of the CSI-RS resource on the neighbour cell configured for measurement is not within the bandwidth of the CSI-RS resource on the serving cell configured for measurement, or the subcarrier spacing of the two CSI-RS resources are different.

In order to perform the switch to the target cell so as to perform the signal quality measurement, a measurement gap is inserted during which no transmission and/or reception happens. Such measurement gaps translate into worsened data performance for the device and limit network scheduling flexibility as these are periods where the device retunes to another frequency solely to perform measurements. It would be then beneficial for the device to always perform serving frequency measurements in its active BWP so as to avoid the need for a measurement gap. However, since the currently active BWP of a device is not known to the layer which signals the measurement configuration (including the indication of the frequency at which measurements are to be carried out), the issue of how to configure such measurements arises.

Furthermore, an additional problem is that, since the active BWPs are invisible to the layer signalling the configuration information, the network may configure measurements objects for each BWP and corresponding measurement events. However, it is often the case that only the measurement results for the active BWPs need to be obtained. If the network is unaware of which BWPs are active, unnecessary measurements and unnecessary reporting may be carried out.

One proposal is that serving cell measurements are performed on so-called cell-defining SS block, which may be outside UE's active BWP and causes issues related to the necessity of measurements gaps as discussed above. Furthermore, it does not address the case where the network would like to perform cell quality derivation based on Channel State Information-Reference Signal (CSI-RS) resources. Furthermore, to make the device always measure its active BWP, the base station would have to configure multiple separate measurement objects (MOs) (i.e. for each configured BWP) and link them with the reporting configuration for handover purposes (e.g. A3 event). However, with currently specified behaviour this would cause the device to measure all these MOs at the same time without consideration of its active BWP.

In an A3 event, a neighbouring cell becomes an amount of offset better than PCell/PSCell. Further information about the A3 event may be found in 3GPP TS 36.331. Although not limited to this specification, in LTE, an A3 event is triggered when a neighbouring cell becomes greater than the serving cell by an offset. The offset can either be positive or negative. The event is triggered when the following conditions are true: Mn+Ofn+Ocn−Hys>Mp+Ofp+Ocp+Off and Mn+Ofn+Ocn+Hys<Mp+Ofp+Ocp+Off, where Mn, Ofn, Ocn, Mp, Ofp, Ocp, Off and Hys parameters are defined in 3GPP TS 36.331.

According to examples of this application, the device may be configured to receive measurement configuration information indicating (via, e.g. a measurement object) at least one frequency at which measurements are to be performed. The device is configured to determine whether a particular frequency indicated in the measurement configuration information is within a predefined frequency range. This may comprise determining whether the particular frequency is within an active BWP of the device for the cell being measured. If the device determines that the frequency is within a predefined frequency range, the device is configured to perform the measurements instructed in the measurement configuration information. Hence, there is no requirement for the measurement configuration information which is signalled by the network to the device, to include an indication of the active frequency ranges.

The predefined frequency ranges may be active frequency ranges. The active frequency ranges may be active BWP.

The measurement configuration information may include a first parameter, which indicates to the device whether or not the measurements should only be performed in the predefined frequency ranges (i.e. the active frequency ranges), or whether they should be performed at the frequencies indicated in the measurement configuration information, irrespective of whether or not those frequencies fall within the predefined frequency ranges. The device may in dependence upon the value of the first parameter, determine to either always measure all of the frequencies indicated for measurement in the configuration information, or to only measure the frequencies indicated for measurement that fall in the active frequency ranges.

The measurement configuration information may further comprise a second parameter, which indicates to the device whether or not measurements should be carried out in a frequency range (e.g. BWP) of a non-active secondary cell. The device may, if the second parameter so indicates, perform measurements in such a frequency range, even though the frequency range is non-active. Such a frequency range is non-active, since the cell is non-active and, therefore, the device does not receive and transmit PUCCH, PUSCH, PDSCH, and PDCCH in the non-active frequency range.

Examples of the application will now be explained in more detail. Throughout the specification, the term bandwidth part (BWP) is used. However, it should be understood that a frequency ranges for transmission and reception more generally may be meant, without being limited to being a particular set of physical resource blocks.

The first parameter may be part of the measurement object configuration, indicating whether a particular MO should be always measured or measured only if it is contained with the UEs active BWP. The parameter may have one of two values. A first value of the parameter may indicate to the device to perform the measurements at all frequencies indicated in the measurement configuration information. A second value of the parameter may indicate to the device to perform the measurements only at those frequencies contained in the active BWP. This criteria (i.e. only perform measurements at those frequencies contained in the active BWP) may alternatively be described as only perform measurements at frequencies such that the measurement is an intra-frequency measurement. The criteria may alternatively be described as only perform measurements at frequencies such that the measurement can be performed without the use of measurement gaps.

Use of the parameter allows a base station (e.g. gNB) to configure MOs and additional configuration information to instruct devices to perform measurements at all the configured BWPs. However, when the first parameter is set to indicate that measurements are only to be performed at frequencies contained in active BWP, the device will not perform these measurements, even though it has received the MO and configuration information for doing so. This provides the dual advantage of allowing the device to perform serving frequency measurements always in its active BWP and to avoid the drawbacks of having to rely on measurement gaps.

In some examples, the measurement configuration information may not include a first parameter. Instead the device may be configured to only perform measurements at frequencies indicated for measurement in the configuration information which fall within the predefined frequency ranges. In this case, this rule may always apply, since no first parameter is received from the base station indicating whether or not to apply this rule or to perform measurements at all the indicated frequencies in the measurement configuration received from the base station.

An additional rule may be applied for handling BWPs associated with the non-primary cells (i.e. secondary cells) and the corresponding measurement objects. When a secondary cells (SCell) is activated, the handling described above, wherein measurement is performed for active BWPs only. For non-activated SCells, measurements may be useful in order to determine when to activate the SCell. However, for non-activated SCells, no BWP is active. To solve this problem, the configuration information may include a second parameter, which indicates to the device whether or not a measurement should be made if the configuration information indicates a measurement is to be made for a non-activated SCell. The second parameter may be combined with the first parameter. This may yield three different options which may be indicated to the device for performing measurements. A first option is to perform measurements at the frequencies indicated in the configuration information even if these frequencies fall outside the active BWPs. A second option is to perform measurements if the frequencies indicated in the configuration information fall within the BWP of a non-active SCell or if they fall within an active BWP of another cell. A third option is for the device to perform the measurements only at those frequencies indicated in the active BWP.

Embodiments of the application provide the advantage of allowing a device to perform the serving frequency measurements specifically on its active BWP and it addresses the case where measurements based on CSI-RS resources are used to derive cell quality (without the need of measurement gaps in both of these cases).

If the first parameter is included in the configuration information, the network retains the possibility to set the measurements outside a device's active BWP if those are deemed beneficial (e.g. for the sake of BWPs reconfiguration).

The first parameter and/or the second parameter discussed above may be included in RRC signalling related to measurement configuration information that is sent from the base station to the device. The first parameter and/or the second parameter may be included in the measurement object of the measurement configuration information that is sent from the base station to the device.

In Abstract Syntax Notation One (ASN.1) notation, the first parameter may be written as: measureOnlyInActiveBWP BOOLEAN. Alternatively, the first parameter may be written as typeOfMeasurement ENUMERATED {alwaysOn, activeBWP-Only, sCellAlwaysOn}. The first parameter may be transmitted through the network using a single bit or multiple bits.

Alternatively, the indication could be implicit and a first parameter not required. The device may measure only one MO per serving cell. The device may only measure at the active BWP. The remaining BWPs may not be measured even if configuration information for them is received. It would be understood by the skilled person that this represents an alternative solution to the particular problem, which also falls within the scope of the application.

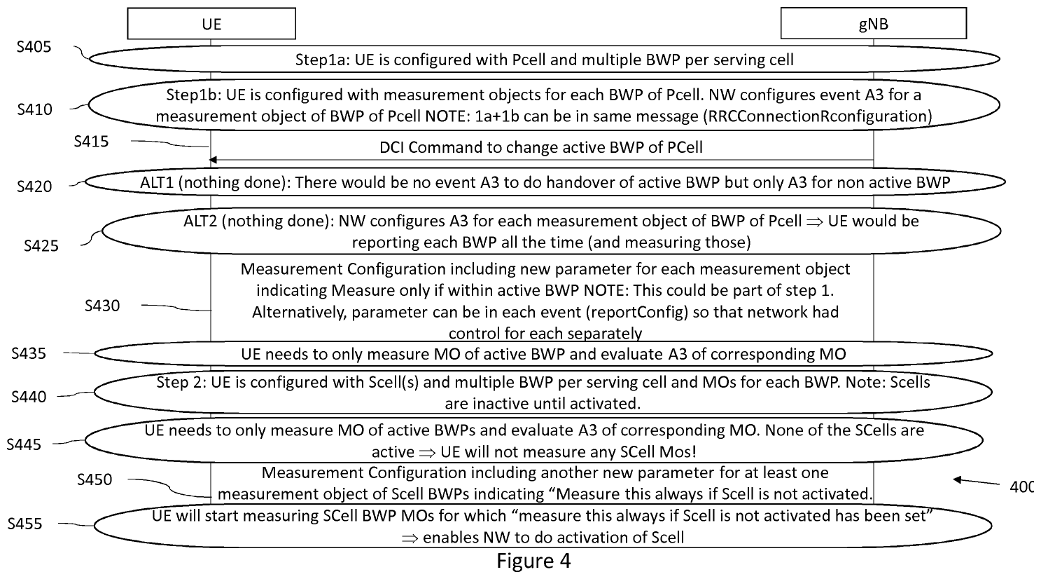

Reference is made to FIG. 4, which shows an example diagram of a new signalling and its possible effect on how device measurements are performed. At S405, the device is configured with primary cell and multiple BWP per serving cell. At S410, the device receives the measurement configuration information for performing the measurements. This may contain a measurement object for each BWP of the primary cell. The device may be configured with these measurement objects for each BWP of the primary cell. The network may configure an A3 event for a measurement object of BWP of primary cell. It should be appreciated that the A3 event is an example only, and that other events may also be configured. Additionally or alternatively, periodic measurements may be performed. The information received at S405 and S410 may be received in the same message.

At S415, a command is received to change the active BWP used for communication between the device and the base station of the primary cell. This command may be layer 1 signalling received from the base station. The command may be a DCI command.

The network may configure A3 events in different ways, depending on what is to be measured. This is discussed with reference to S420 and S425.

At S420, according to one example, there is no A3 event for performing handover of active BWP. Instead, there is only an A3 event for non-active BWP.

At S425, according to another example, the network configures an A3 event for each measurement object of BWP of PCell. The device may be configured to report measurements at each BWP.

At S430, measurement configuration information including the first parameter is transmitted from the base station to the device. The measurement configuration information includes a copy of the first parameter for each measurement object.

At S435, the device needs to only measure MO of active BWP and evaluate an A3 event of the corresponding MO.

At S440, is configured with SCell(s) and multiple BWP per serving cell. The device receives configuration information having multiple BWP per serving cell and MOs for each BWP.

At S445, the device measures at frequencies in the active BWPs only in accordance with the first parameter included in the measurement configuration information. In this example, the BWP of non-active SCells will not be measured by the device.

At S450, the device receives the second parameter from the base station. The measurement configuration information includes a copy of the second parameter for each measurement object. The second parameter in this case, indicates that frequencies falling within the BWP of the SCell should be measured by the device if the SCell is not activated.

At S455, the device performs measurements at frequencies in the BWP of SCells which are not activated. The results of the measurements are communicated back the base station, allowing the network to do activation of the SCell.

There are multiple different options available as to how Layer 3 (L3) filtering may be applied when the proposed parameters are configured. These multiple options may be configured by the network using another parameter. The purpose of Layer 3 filtering is to perform averaging of the measurement samples so that instantaneous signal fluctuations do not affect the reported values or do not trigger reporting events unnecessarily. The filter may be defined as follows: Fₙ=(1−a)·Fₙ₋₁+a·Mₙ, where Mₙ is the latest received measurement result from the physical layer; Fₙ is the updated filtered measurement result, that is used for evaluation of reporting criteria or for measurement reporting; Fₙ₋₁ is the old filtered measurement result, where F₀ is set to M₁ when the first measurement result from the physical layer is received; and a=½^{(k/4)}, where k is the filterCoefficient for the corresponding measurement quantity received by the quantityConfig.

One option as to how L3 filtering is to be applied is the “Reset L3 filter” option. In this case, the device may reset the L3 filter whenever the active BWP is switched. Another option is the “continue L3 filter” option. In this case, the device would not reset the L3 filter, but would feed new measurement samples (from new active BWP) to the input of the filter. Another option is the “suspend filter”. In this case, the device would maintain a filter per BWP and suspend/resume it when BWP part is activated/deactivated. Alternatively, one of the above options could be hard-coded in the specifications.

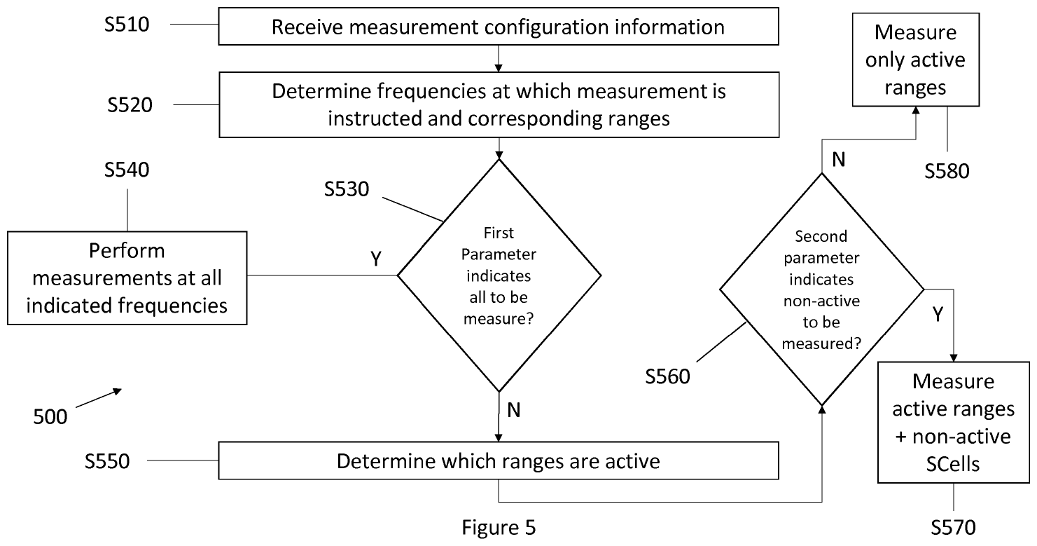

Reference is made to FIG. 5, which shows an example of a method that may be performed at a device 500 in accordance with examples of the application. It would be appreciated by the skilled person that the method 500 is an example only and that not all the steps need be essential. In some examples, one or steps may be omitted. In some examples, the order of the steps may be changed.

At S510, the device is configured to receive measurement configuration information form a base station. The measurement configuration information may comprise a plurality of measurement objects indicating frequencies and cells for which measurements are to be carried out by the device. The measurement configuration information may also include a first parameter and a second parameter, which have been defined previously.

At S520, the device is configured to determine the frequencies at which measurement is instructed from the measurement configuration information. The device may determine the frequency ranges reserved for transmission and reception (i.e. the BWP) and determine which ranges measurement is instructed for.

At S530, the device is configured to determine if the first parameter indicates that measurement is to be performed in all of the ranges in which measurement is instructed or if measurement is to be performed in only the active ranges, which are presently in use by the device.

If it is decided that all ranges should be measured, at S540, the device performs the measurements at all of the frequencies indicated in S510, and communicates the results in a measurement report to the base station.

If it is decided that only the active ranges should be measured, at S550, the device is configured to determine which ranges are active.

At S560, it is determined whether or the second parameter indicates whether the BWPs of the non-active SCells are to be measured. If not, at S580, measurements are performed in only the active ranges the results are reported to the base station. If so, at S570, measurements in the active ranges and the non-active ranges of the non-active SCells are made and are reported to the base station.

Hence in the method 500, the device performs at least one measurement at a frequency in response to determining that the frequency is within one or more of the predefined frequency ranges.

It is noted that whilst examples have been described in relation to one example of a standalone LTE network and New Radio, similar principles may be applied in relation to other examples of standalone 3G, LTE or 5G networks. It should be noted that other examples may be based on other cellular technology other than LTE or on variants of LTE. It should also be noted that other examples may be based on standards other than New Radio or on variants of New Radio. Therefore, although certain examples were described above by way of example with reference to certain example architectures for wireless networks, technologies and standards, examples may be applied to any other suitable forms of communication systems than those illustrated and described herein.

It is also noted herein that while the above describes example examples, there are several variations and modifications which may be made to the disclosed solution without departing from the scope of the present invention.

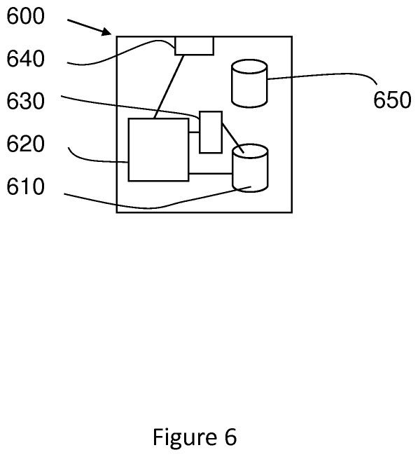

The method may additionally be implemented in a control apparatus as shown in FIG. 13. The method may be implemented in a single processor 201 or control apparatus or across more than one processor or control apparatus. FIG. 6 shows an example of a control apparatus 600 for a communication system, for example to be coupled to and/or for controlling a station of an access system, such as a RAN node, e.g. a base station, (e) node B, a central unit of a cloud architecture or a node of a core network such as an MME or S-GW, a scheduling entity such as a spectrum management entity, or a server or host. The control apparatus may be integrated with or external to a node or module of a core network or RAN. In some examples, base stations comprise a separate control apparatus unit or module. In other examples, the control apparatus can be another network element such as a radio network controller or a spectrum controller. In some examples, each base station may have such a control apparatus as well as a control apparatus being provided in a radio network controller. The control apparatus 600 can be arranged to provide control on communications in the service area of the system. The control apparatus 600 comprises at least one random access memory 610, at least one read only memory 650 at least one data processing unit 620, 630 and an input/output interface 640. The at least one random access memory 610 and the at least one read only memory 650 are in communication with the at least one data processing unit 620, 630. Via the interface, the control apparatus can be coupled to a receiver and a transmitter of the base station. The receiver and/or the transmitter may be implemented as a radio front end or a remote radio head. For example, the control apparatus 600 or processor 201 can be configured to execute an appropriate software code to provide the control functions.

Control functions may comprise a method comprising: receiving measurement configuration information, the measurement configuration information comprising: an indication of a plurality of frequencies at which measurements are to be performed; and a first parameter; performing, in dependence upon the first parameter, one of: if the first parameter has a first value, measurements at the indicated plurality of frequencies; and if the first parameter has a second value, measurements at only one or more of the plurality of frequencies which fall within one or more predefined frequency ranges.

Alternatively, or in addition, control functions may comprise transmitting measurement configuration information, the measurement configuration information comprising: an indication of a plurality of frequencies at which measurements are to be performed; and a first parameter; receiving, in dependence upon the first parameter, one of: if the first parameter has a first value, results of measurements made at the indicated plurality of frequencies; and if the first parameter has a second value, results of measurements made at only one or more of the plurality of frequencies which fall within one or more predefined frequency ranges.

Alternatively, or in addition, control functions may comprise a method comprising: receiving measurement configuration information, the measurement configuration information comprising an indication of a plurality of frequencies at which measurements are to be performed; and performing the measurements only at one or more of the frequencies which fall within one or more predefined frequency ranges.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various examples may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out examples. The one or more computer-executable components may be at least one software code or portions of it.

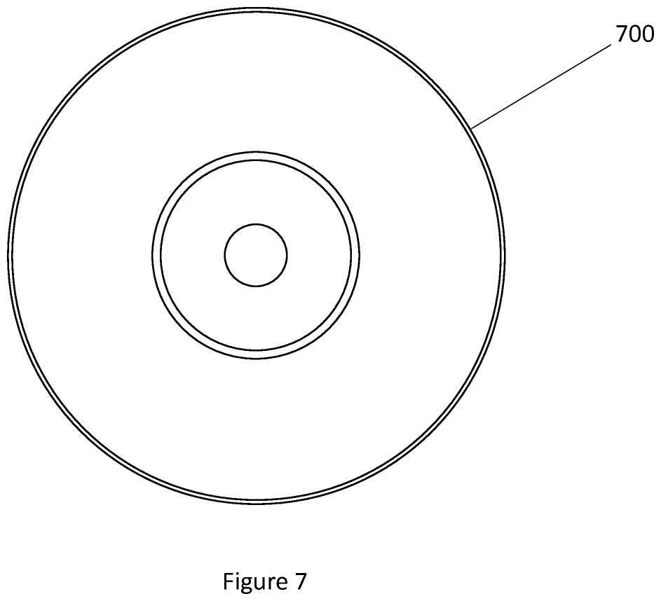

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. An example of a non-transitory computer readable medium 700 is shown in FIG. 7. The non-transitory computer readable medium 700 may be a CD or DVD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Examples of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary example of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further example comprising a combination of one or more examples with any of the other examples previously discussed.

1. A method comprising:
receiving, by a user device, measurement configuration information, the measurement configuration information comprising:
an indication of a plurality of frequencies at which measurements are to be performed; and
a first parameter;
performing, by the user device in dependence upon the first parameter, one of:
if the first parameter has a first value, measurements at the indicated plurality of frequencies, including at least one inter-frequency measurement at a frequency that is not within an active bandwidth part of the user device via use of a measurement gap; and
if the first parameter has a second value, only one or more intra-frequency measurements at frequencies that are within the active bandwidth part of the user device without using a measurement gap.

2. A method as claimed in claim 1, wherein the measurement configuration information comprises a second parameter that indicates whether or not the user device should perform a measurement of a frequency within a bandwidth part of a non-activated secondary cell,
wherein the performing further comprises performing, by the user device, a measurement of a frequency within a bandwidth part of a non-activated secondary cell if the second parameter indicates that the user device should perform a measurement of a frequency within a bandwidth part of a non-activated secondary cell.

3. A method as claimed in claim 2, wherein the first parameter and the second parameter are part of a combined parameter.

4. A method comprising:
receiving, by a user device, measurement configuration information, the measurement configuration information comprising:
an indication of a plurality of frequencies at which measurements are to be performed; and
a first parameter indicating that measurements should be performed only at frequencies that are within an active bandwidth part of the user device;
performing, by the user device based upon the first parameter, only one or more intra-frequency measurements at frequencies that are within the active bandwidth part of the user device without using a measurement gap.

5. A method according to claim 1, wherein the measurements comprise one or more of measurements of: a block error rate, a transmit power, a reference signal received power (RSRP), a reference signal received quality (RSRQ), and/or a signal to interference and noise ratio (SINR).

6-7. (canceled)

8. A method as claimed in claim 1, wherein the measurement configuration information comprises a measurement object providing the indication of a plurality of frequencies at which measurements are to be performed.

9. A method as claimed in claim 1, comprising receiving Radio Resource Control layer signalling comprising the measurement configuration information.

10. A method as claimed in claim 1, comprising:
performing filtering of measurement results made within the active bandwidth part of the user device using a filter; and
in response to a change in the active bandwidth part of the user device to a new active bandwidth part of the user device, performing at least one of:
resetting the filter; and
filtering new measurement results made within the new active bandwidth part of the user device using the filter.

11. A method as claimed in claim 1, comprising:
associating a filter with each of a plurality of bandwidth parts for the filtering of measurement results made within the bandwidth part;
in response to one of the plurality of bandwidth parts becoming active, activating the filter associated with that bandwidth part; and
in response to one of the plurality of bandwidth parts becoming non active, deactivating the filter associated with that non-active bandwidth part.

12. A method comprising:
transmitting, to a user device, measurement configuration information, the measurement configuration information comprising:
an indication of a plurality of frequencies at which measurements are to be performed; and
a first parameter;
receiving, in dependence upon the first parameter, one of:
if the first parameter has a first value, results of measurements made at the indicated plurality of frequencies, including a result of at least one inter-frequency measurement at a frequency that is not within an active bandwidth part of the user device via use of a measurement gap; and
if the first parameter has a second value, results of intra-frequency measurements, without use of a measurement gap, made at only one or more of the plurality of frequencies which fall within the active bandwidth part of the user device.

13-16. (canceled)

17. A user device comprising:
at least one processor and at least one memory including a computer program code, the at least one memory and the computer program code configured to, with the at least one processor, cause the apparatus at least to:
receive, by a user device, measurement configuration information, the measurement configuration information comprising:
an indication of a plurality of frequencies at which measurements are to be performed; and
a first parameter; and
perform, by the user device in dependence upon the first parameter, one of:
if the first parameter has a first value, measurements at the indicated plurality of frequencies, including at least one inter-frequency measurement at a frequency that is not within an active bandwidth part of the user device via use of a measurement gap; and
if the first parameter has a second value, only one or more intra-frequency measurements at frequencies that are within the active bandwidth part of the user device without using a measurement gap.

18. A user device comprising:
at least one processor and at least one memory including a computer program code, the at least one memory and the computer program code configured to, with the at least one processor, cause the apparatus at least to:
receive, by a user device, measurement configuration information, the measurement configuration information comprising:
an indication of a plurality of frequencies at which measurements are to be performed; and
a first parameter indicating that measurements should be performed only at frequencies that are within an active bandwidth part of the user device; and
perform, by the user device based upon the first parameter, only one or more intra-frequency measurements at frequencies that are within the active bandwidth part of the user device without using a measurement gap.
